(19) United States
(12) Patent Application Publication
(10) Pub. No.: US 2017/0166402 A1
(43) Pub. Date: Jun. 15, 2017

(54) MICRO-TRANSFER CONVEYOR

(71) Applicant: Nercon Eng. & Mfg., Inc., Neenah, WI (US)

(72) Inventors: Michael Weickert, Oshkosh, WI (US); Daniel Mentzel, Neenah, WI (US); Andrew Rottier, Green Bay, WI (US)

(73) Assignee: NERCON ENG. & MFG., INC., Neenah, WI (US)

(21) Appl. No.: 14/835,416

(22) Filed: Aug. 25, 2015

(51) Int. Cl. B65G 15/24; B65G 37/00; B65G 21/14

(52) U.S. Cl. CPC B65G 15/24; B65G 21/14; B65G 37/00

(57) ABSTRACT

A transfer conveyor for transferring conveyed items between two main conveyors, each having a flexible conveying surface reeved about an end sprocket that is large with respect to the conveyed items. The transfer conveyor includes a deck having two ends, each having a nose bar. At least one tensioning idler wheel is slidably mounted to the transfer conveyor frame, and a drive wheel is rotatably mounted to the frame. A transfer conveyor belt is routed about the drive wheel, over the tensioning idler wheel, over the deck, and back to the drive wheel. A dead plate is positioned between one of the nose bars and one of the main conveyors, at a level even with the top of the belt. The deck is expandable, formed of two interlaced finger plates, each having a respective nose bar at one end and finger(s) extending away from the nose bar.

### BACKGROUND OF THE INVENTION

The present invention relates generally to the field of conveyors, and specifically to transfer conveyors for transferring conveyed items from one larger conveyor to another.

It is known to construct a conveyor to include a movable conveying surface, for conveying items from one place to another, commonly, for instance, inside an industrial factory. It is known to construct the conveying surface from materials such as a flexible belt, or a chain formed of links that are rotatable with respect to each other. It is further known to reeve the belt or chain conveying surface about an end reel at each end of the conveyor. FIGS. 1 and 2 show two conventional conveyors 10 and 10a abutting each other, each constructed in that manner, each with a chain link conveying surface 12 and 12a for conveying conveyed items 14, 14a. Each conveyor 10, 10a includes a pulley or sprocket 16, 16a (FIG. 2), at the end of the respective conveyor, about which the respective conveying surface 12, 12a is reeved. Each pulley or sprocket 16, 16a is rotatably connected, or journaled, to a respective conveyor frame 18, 18a. As can be seen at FIG. 2, in order to bear the load of the conveying surface 12, 12a and the conveyed items 14, 14a, and so as not to overly flex the links of the conveyor chain, the pulley or sprocket 16, 16a must be of substantial size with respect to the other parts shown, normally in the range of 2.3 to 6.4 inches, with the 5.8 inch size being most common due to the high speed nature of modern assembly lines, and to ensure proper engagement between the sprocket and the conveyor chain. The larger sizes are used to achieve higher conveyor speeds without excess shaft RPM. Thus when two conveyors are arranged end to end as shown in FIGS. 1 and 2, there is necessarily a gap 20 in the conveying surface, that is, a gap between the end of the top surface of one main conveyor 10 and the top surface of the other conveyor 10a. Using the dimensions set forth just above, and including necessary clearances and tolerances between the abutting conveyors, the gap 20 could be as large as 6-7 inches[correct?]. As shown in the figures, there is a risk that a conveyed item 14a could fall into this gap 20, and the conveying function of the conveyor could be disrupted. This problem can be especially acute where the conveyed item 14a is relatively small compared to the gap 20, or where the conveyed item is a package that is flexible, such a pouch. Existing solutions to this problem normally use a simple, non-powered bridge, such as with a fixed or roller surface. These solutions only solve the problem of having the products not fall into the gap, but create the new problem of products being stranded on the bridge, especially for small and/or flexible items, because those are exactly the types of items that will not move across the bridge without force from other conveyed items coming from the conveyor behind them.

The present invention relates to improvements over the apparatus described above and to solutions to some of the problems raised or not solved thereby.

### SUMMARY OF THE INVENTION

The invention provides a transfer conveyor for transferring conveyed items from one main conveyor to another main conveyor, each of those main conveyors having a flexible conveying surface reeved about an end sprocket that is large with respect to the conveyed items. The transfer conveyor includes a transfer conveyor frame, and a deck mounted to the transfer conveyor frame and having two ends, each end of the deck terminating in a nose bar. At least one tensioning idler wheel is rotatably and slidably mounted to the transfer conveyor frame. A drive wheel is rotatably mounted to the frame. A transfer conveyor belt is routed about the drive wheel, over the at least one tensioning idler wheel, over the nose bar at one end of the deck, over the deck, over the nose bar at the other end of the deck, and back to the drive wheel. The deck is expandable in that the nose bars are movable away from each other, since the deck is formed of two interlaced finger plates, each having a respective one of the nose bars at one end of the respective finger plate, each finger plate having at least one finger extending away from its respective nose bar, so that the finger of one finger plate lies alongside the finger of the opposite finger plate. Each finger plate may include a recess for receiving the finger of the opposite finger plate. A dead plate may be positioned between one of the nose bars and one of the first and second main conveyors, at a level substantially even with the top of the belt when the belt is on the deck.

Other objects and advantages of the invention will become apparent hereinafter.

### DESCRIPTION OF THE DRAWING

FIG. 1 is a perspective view of a pair of conventional conveyors butted up to each other, and carrying conveyed items.

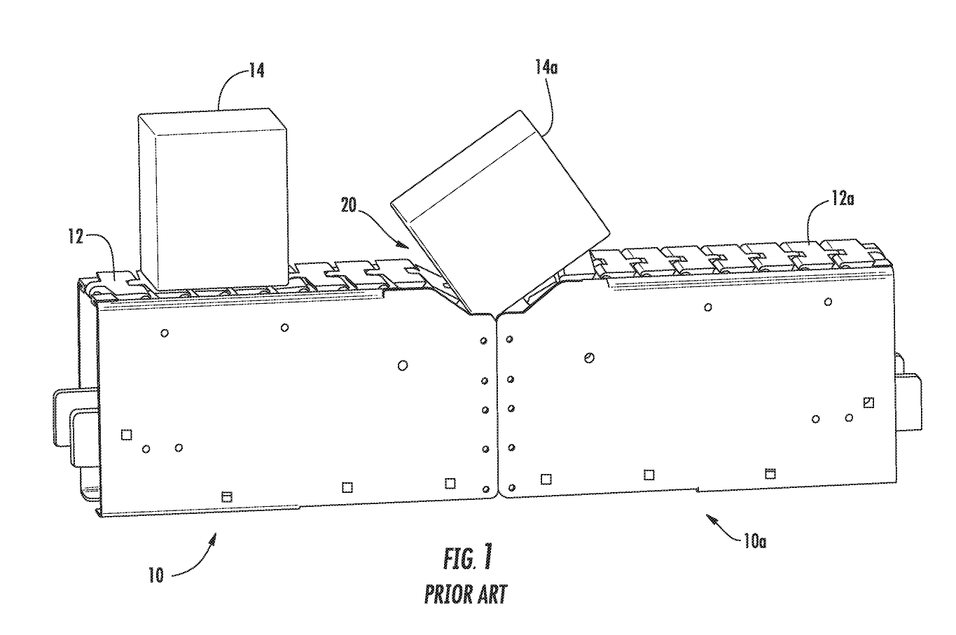

FIG. 2 is a side elevation view of the conveyors shown in FIG. 1, with a side plate of the conveyor removed to show the sprockets inside.

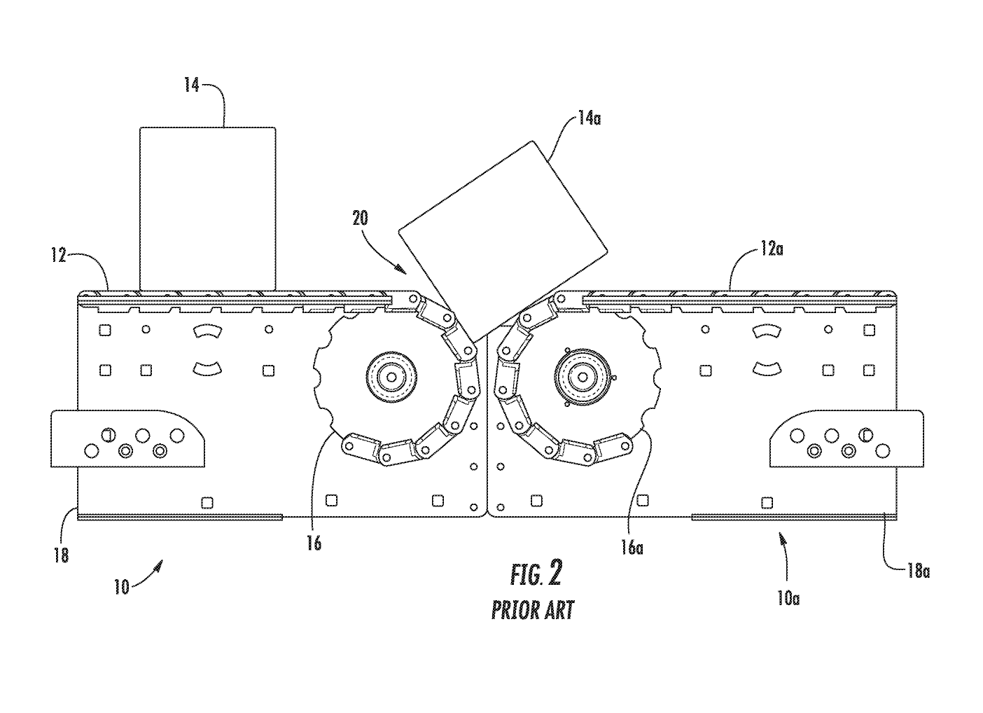

FIG. 3 is a perspective view of a pair of conventional conveyors, having a transfer conveyor inserted between them, and constructed according to a preferred embodiment of the invention.

FIG. 4 is a side elevation view of the conventional conveyors and transfer conveyor shown in FIG. 3.

FIG. 5 is an enlarged side elevation view of the transfer conveyor alone, constructed according to a preferred embodiment of the invention.

FIG. 6 is a perspective view of the transfer conveyor shown in FIG. 5.

FIG. 7 is a side elevation view of the transfer conveyor shown in FIG. 6, with part of the frame cut away so as to reveal the inside of the transfer conveyor.

FIG. 8 is an enlarged side elevation view of a circled portion of FIG. 7, to show the nose bar in greater detail.

FIG. 9 is an upper perspective view of the transfer conveyor shown in FIG. 5, with the belt removed to show the structure allowing the deck to be expanded.

FIG. 10 is a perspective view of the transfer conveyor, similar to FIG. 9, but with the deck in the expanded position.

FIG. 11 is a perspective view of the transfer conveyor, similar to FIG. 6, but with the deck in the expanded position.

FIG. 12 is an enlarged side elevation view of a circled portion of FIG. 4.

### DETAILED DESCRIPTION

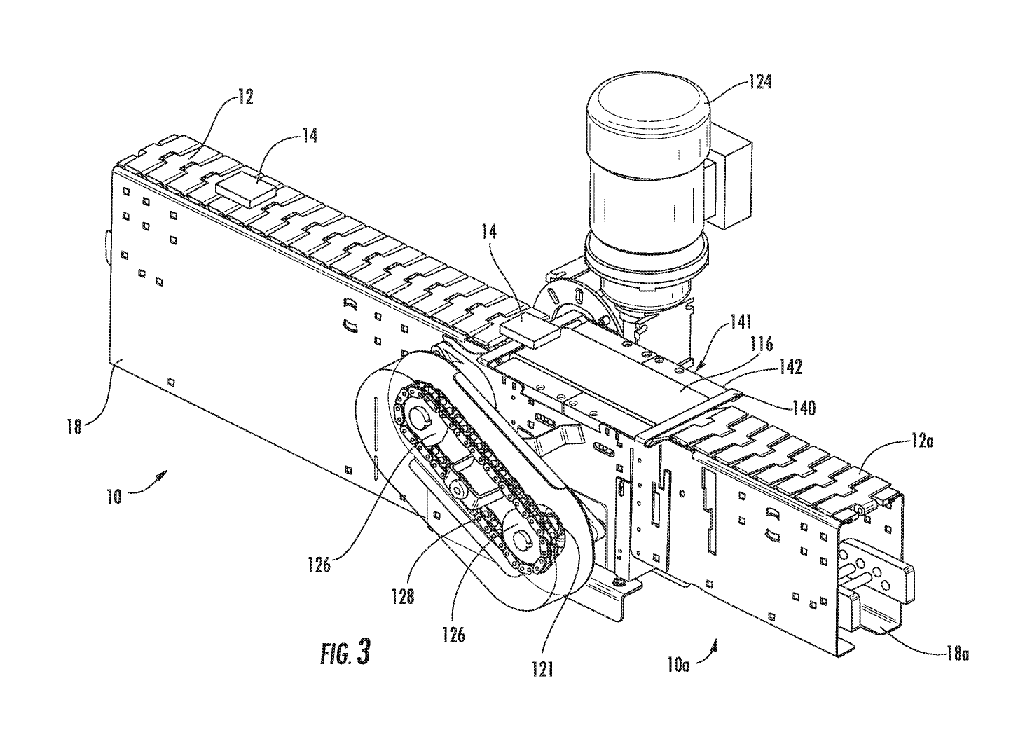

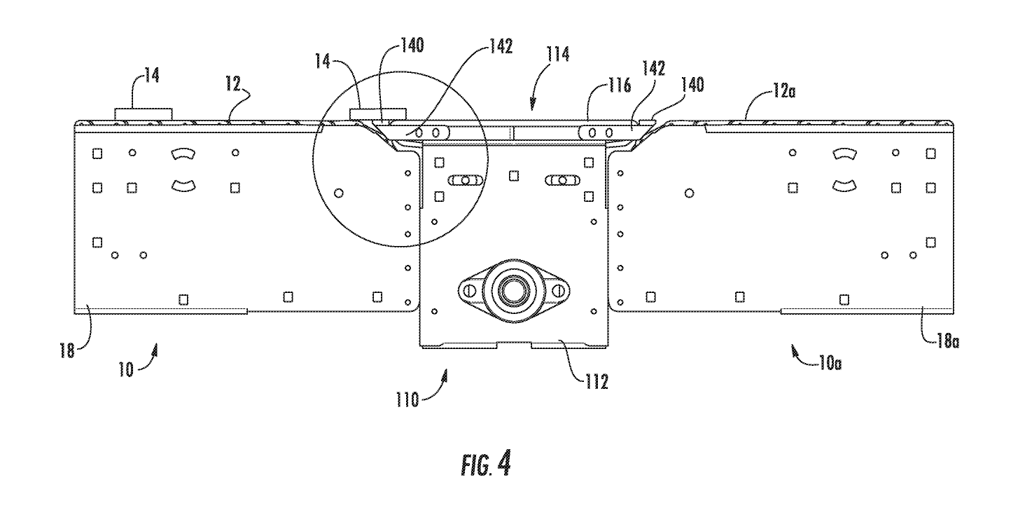

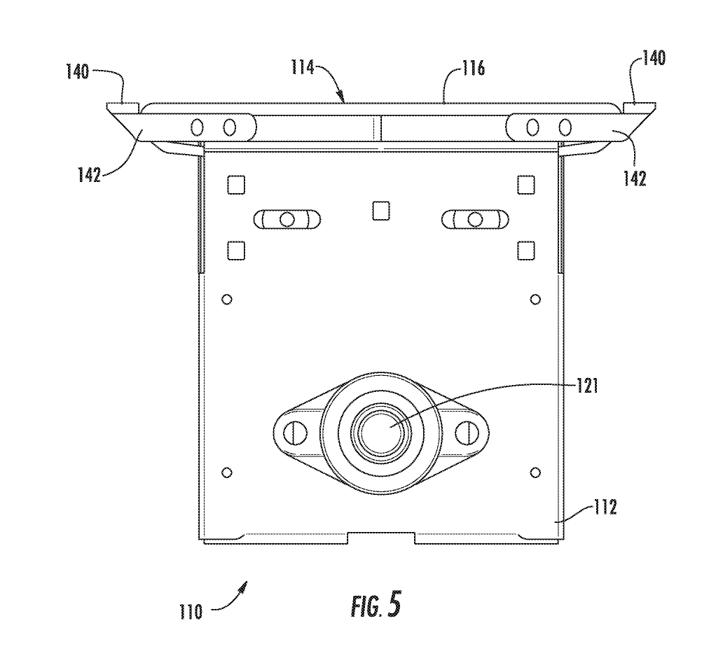

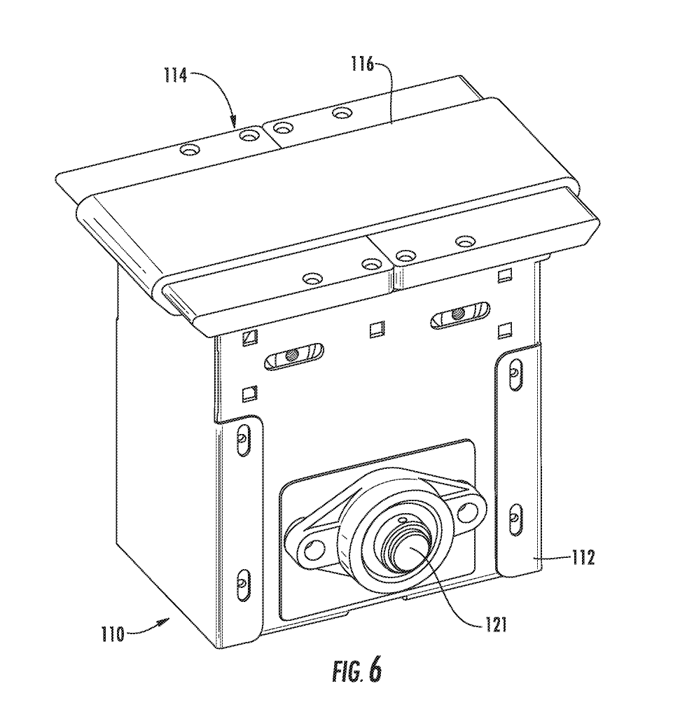

Referring now to FIGS. 3 and 4, the invention provides a transfer conveyor 110, positioned between two conventional or main conveyors 10 and 10a. According to the embodiment shown, the transfer conveyor 110 includes a transfer conveyor frame 112. Mounted to the top of the transfer conveyor frame 112 is a deck 114. Overlaying the top surface of the deck 114 is a transfer conveyor belt 116, the routing and motion of which will be described in more detail below. FIGS. 5 and 6 are views of the transfer conveyor 110 that are similar to those shown in FIGS. 4 and 3, respectively, except that the main conveyors 10 and 10a are removed for clarity.

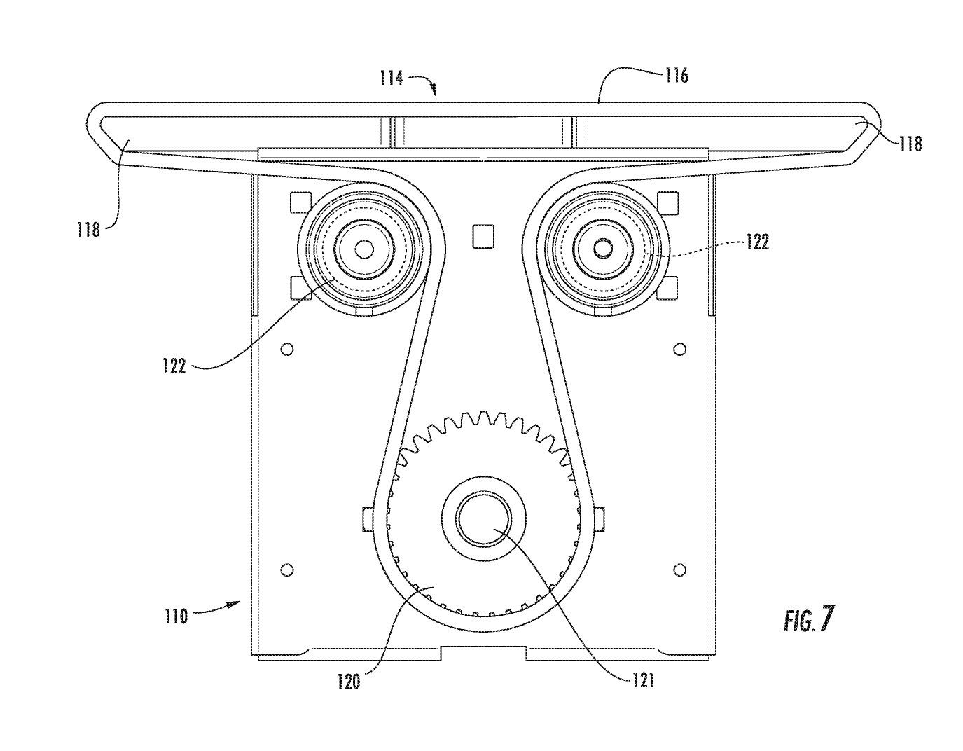

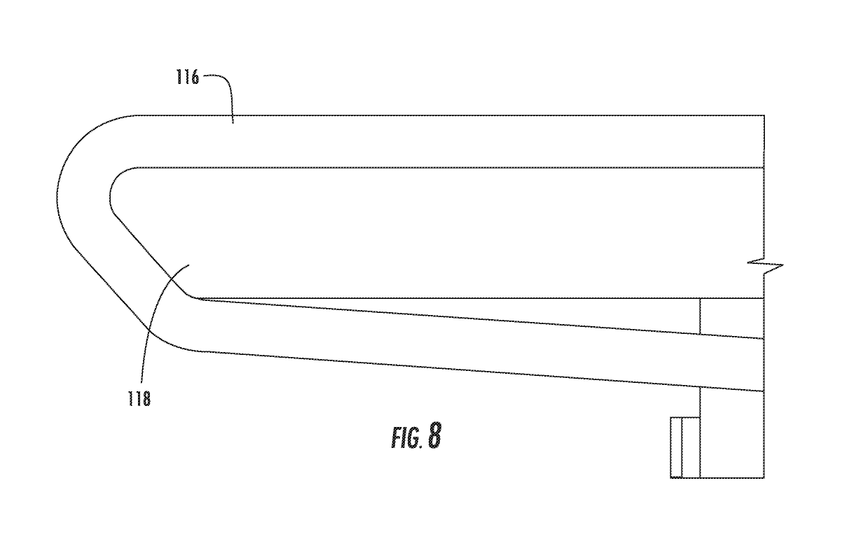

FIG. 7 is a figure similar to FIG. 5, except with part of the transfer conveyor frame 112 cut away to reveal the inside of the transfer conveyor 110. As shown in FIG. 7, and as described above, the transfer conveyor belt 116 overlies the top surface of the deck 114. Each end of the deck 114 terminates in a nose bar 118, shown in greater detail in FIG. 8. As can be seen in FIG. 7, the transfer conveyor 110 further includes a drive sprocket 120, mounted to a drive shaft 121 which is in turn journaled to the transfer conveyor frame 112. At least one tensioning idler wheel 122 is also journaled to the transfer conveyor frame. The embodiment shown in FIG. 7 includes two tensioning idler wheels 122, one positioned nearer each end of the transfer conveyor 110, that is, closer to each respective end of the deck 114, so as to provide a symmetrical design that allows for forward and reverse (bi-directional) operation of the transfer conveyor, while also providing maximum clearance for sprockets 16, 16a of main conveyors 10, 10a, and to provide maximum range and symmetry of tensioning adjustment. Each of the tensioning idler wheels 122 is mounted to the transfer conveyor frame 112 in such a way as to enable to the respective tensioning idler wheel to be moved with respect to the transfer conveyor frame, and fixed in several different positions, so as to accomplish the tensioning function. As can be seen, then, by comparing FIGS. 7 and 8, the transfer conveyor belt 116 is an endless belt that passes from the top surface of the deck 114, over one of the nose bars 118, to be reeved about one of the tensioning idler wheels 122, engaged with the drive sprocket 120, reeved about the other of the tensioning idler wheels, over the other of the nose bars, and back to the top surface of the deck. While the nose bars 118 are shown in this embodiment as static and frictional, in an alternative embodiment the nose bars 118 could be dynamic, provided with a roller mounted via bearings so as to permit rotation with respect to the deck 114.

The driving force rotating the drive shaft 121, and thereby the drive sprocket 120, can be any suitable prime mover. In the embodiment shown in FIG. 3, the drive shaft is driven by a motor 124 originally supplied for the purpose of driving the main conveyor 10a, by means of a set of sprockets 126 and chain 128. Alternatively, drive shaft 121 could be connected to its own drive motor (not shown). Other suitable means for rotating the drive shaft 121 will be known to persons of skill in this art.

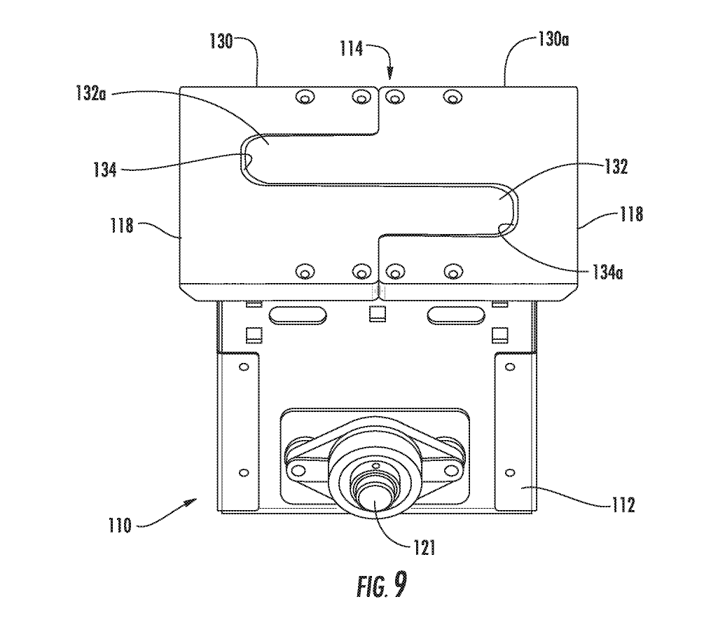

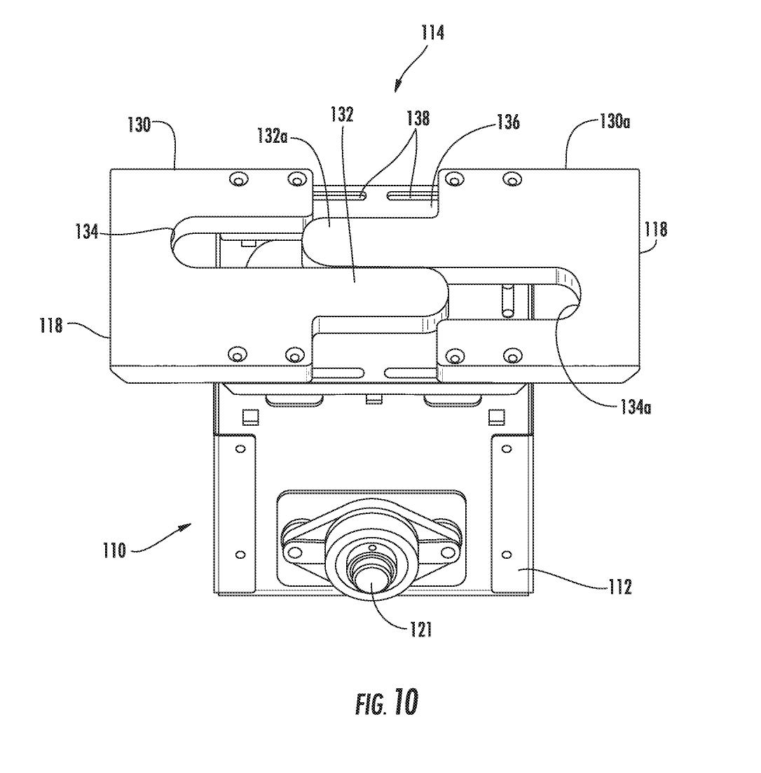

As shown in FIGS. 9 through 11, the deck 114 is expandable in the direction of movement of the transfer conveyor belt 116, so as to reduce as much as practical any gap between the end of the main conveyor and the end of the transfer conveyor. As can be seen best in FIGS. 9 and 10, according to this embodiment, the deck 114 is formed of two finger plates 130 and 130a. Although as shown in FIGS. 9 and 10 as identical, such identity of structure between the two finger plates 130, 130a is not required. That is, the two finger plates 130, 130a could have different shapes from each other, and could have different shapes than those shown, as long as a reasonable amount of support is provided to the flexible transfer conveyor belt 116, as the flexibility of the belt could be such that it may not support itself over a gap of any substantial amount. Each finger plate 130, 130a has at least one respective finger 132 and 132a extending outward away from its respective nose bar 118, and an appropriate number of finger recesses 134 and 134a to accommodate the finger(s) of the opposite finger plate. When the deck 114 is in its unexpanded position as shown in FIG. 9, there preferably should be no substantial area where the transfer conveyor belt 116 is not supported. When the deck 114 is in its expanded position as shown in FIG. 10, there still should be no substantial length of the transfer conveyor belt 116 has no support.

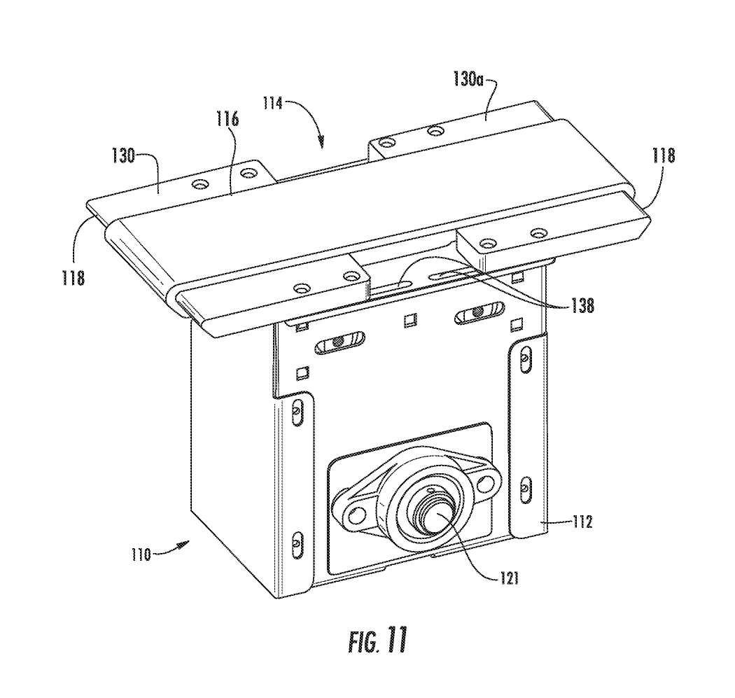

While various structures for supporting and affixing the finger plates 130, 130a may be provided, as can be seen best in FIG. 10, in this embodiment the finger plates 130, 130a rest on and are fastened to a deck support plate 136 beneath the deck 114. The deck support plate 136 may be fastened to or formed as part of the transfer conveyor frame 112. The finger plates 130, 130a are fastened to the deck support plate 136 by means of slots 138 formed in the deck support plate. Alternatively, finger plates 130, 130a could have slots, and there could be simple holes formed in the deck support plate 136. FIGS. 10 and 11, then, show the transfer conveyor 110 with its finger support plates 130, 130a extended to their maximum extent. It can thus be seen, by comparing FIG. 11 with FIG. 6, the extent to which the length of the deck 14 can be varied.

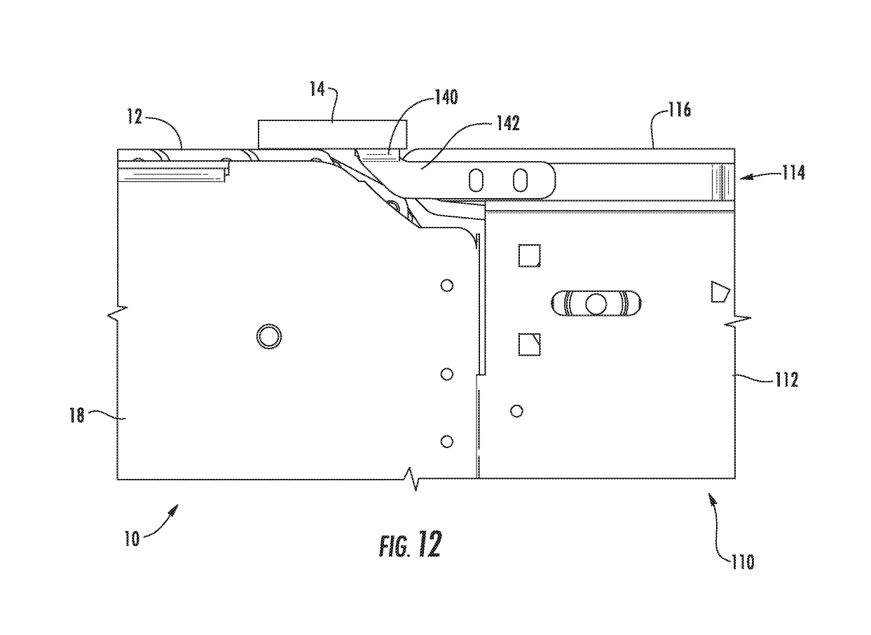

In order to further reduce any gap between one of the main conveyors 10, 10a, and the transfer conveyor 110, one embodiment of the invention provides a dead plate 140, shown best in FIGS. 3, 4 and 12, positioned between one of the nose bars 118 and one of the first and second main conveyors 10, 10a. In the embodiment shown, dead plate 140 is a flat plate, formed of relatively rigid material such as metal. The length of the dead plate 140 is about the width of the transfer conveyor 110. As shown best in FIG. 12, dead plate 140 is supported such that the top surface of the dead plate is substantially even with, to just slightly below, the top surface of the transfer conveyor belt 116 and the conveying surface 12. In this embodiment dead plate 140 is supported at each of its ends by mounting arms 142, which are bolted or otherwise fastened in place, such as by fastening the mounting arms to the sides of the finger support plates 130, 130a. As can be seen in the figures, the width of the dead plate is relatively narrow, but wide enough, as shown best in FIG. 12, to provide additional support to small conveyed items 14 as they transition from the main conveyor 10 to the transfer conveyor 110, or, at the opposite end of the transfer conveyor, as they transition from the transfer conveyor to the main conveyor 10a. Alternatively, a roller could be substituted for the dead plate.

While the apparatus hereinbefore described is effectively adapted to fulfill its intended objects, it is to be understood that the invention is not intended to be limited to the specific preferred embodiments set forth above. Rather, it is to be taken as including all reasonable equivalents to the subject matter described.

We claim:

1. A transfer conveyor for transferring conveyed items from a first main conveyor to a second main conveyor, each of the first and second main conveyors having a flexible conveying surface reeved about an end sprocket that is large with respect to the conveyed items, the transfer conveyor comprising:
a transfer conveyor frame;
a deck mounted to the transfer conveyor frame and having two ends, each end of the deck terminating in a nose bar;
at least one tensioning idler wheel, rotatably and slidably mounted to the transfer conveyor frame;
a drive wheel rotatably mounted to the frame; and
a transfer conveyor belt routed about the drive wheel, over the at least one tensioning idler wheel, over the nose bar at one end of the deck, over the deck, over the nose bar at the other end of the deck, and back to the drive wheel, so as to be moved by the drive wheel from one end of the deck toward the other end.

2. A transfer conveyor as recited in claim 1 further comprising a dead plate positioned between one of the nose bars and one of the first and second main conveyors, at a level substantially even with the top of the belt when the belt is on the deck.

3. A transfer conveyor as recited in claim 1 wherein the deck is expandable in that the nose bars are movable away from each other.

4. A transfer conveyor as recited in claim 1 wherein the deck is formed of two interlaced finger plates, each having a respective one of the nose bars at one end of the respective finger plate, each finger plate having at least one finger extending away from its respective nose bar.

5. A transfer conveyor as recited in claim 4 wherein each finger plate includes a recess for receiving the finger of the opposite finger plate.

6. A transfer conveyor as recited in claim 4 wherein and the at least one finger of each finger plate offset from center on the finger plate.

7. A transfer conveyor as recited in claim 4 wherein the finger of one finger plate lies alongside the finger of the opposite finger plate.

8. A conveyor comprising:
a conveyor frame;
an expandable deck mounted to the conveyor frame and having two ends, each end of the deck terminating in a nose bar;
at least one tensioning idler wheel, and a drive wheel, both rotatably mounted to the conveyor frame;
a conveyor belt driven by the drive wheel and reeved over the at least one tensioning idler wheel and over the deck, so as to be moved by the drive wheel from one end of the deck toward the other end.

9. A conveyor as recited in claim 8 wherein the deck is formed of two interlaced finger plates, each having a respective one of the nose bars at one end of the respective finger plate, each finger plate having at least one finger extending away from its respective nose bar.

10. A conveyor as recited in claim 9 wherein each finger plate includes a recess for receiving the finger of the opposite finger plate.

11. A conveyor as recited in claim 9 wherein and the at least one finger of each finger plate offset from center on the finger plate.

12. A conveyor as recited in claim 9 wherein the finger of one finger plate lies alongside the finger of the opposite finger plate.

13. A transfer conveyor for transferring conveyed items from a first main conveyor to a second main conveyor, each of the first and second main conveyors having a flexible conveying surface reeved about an end sprocket that is large with respect to the conveyed items, the transfer conveyor comprising:
a transfer conveyor frame;
a deck mounted to the transfer conveyor frame and having two ends, each end of the deck terminating in a nose bar, the deck being formed of two interlaced finger plates, each having a respective one of the nose bars at one end of the respective finger plate, each finger plate having at least one finger extending away from its respective nose bar, and each finger plate including a recess for receiving the finger of the opposite finger plate;
at least one tensioning idler wheel, rotatably and slidably mounted to the transfer conveyor frame;
a drive wheel rotatably mounted to the frame; and
a transfer conveyor belt routed about the drive wheel, over the at least one tensioning idler wheel, over the nose bar at one end of the deck, over the deck, over the nose bar at the other end of the deck, and back to the drive wheel, so as to be moved by the drive wheel from one end of the deck toward the other end.

14. A transfer conveyor as recited in claim 13 wherein and the at least one finger of each finger plate offset from center on the finger plate.

15. A transfer conveyor as recited in claim 13 wherein the finger of one finger plate lies alongside the finger of the opposite finger plate.

16. A transfer conveyor as recited in claim 13 further comprising a dead plate positioned between one of the nose bars and one of the first and second main conveyors, at a level substantially even with the top of the belt when the belt is on the deck.
